(19) United States
(12) Patent Application Publication
(10) Pub. No.: US 2023/0373683 A1
(43) Pub. Date: Nov. 23, 2023

(54) WRAPPING DEVICE HAVING CORNER PROTECTORS FOR SECURING AND SUPPORTING PALLETIZED MATERIALS

(71) Applicant: HUALONG WANG, APEX, NC (US)

(72) Inventor: HUALONG WANG, APEX, NC (US)

(21) Appl. No.: 18/200,521

(22) Filed: May 22, 2023

Related U.S. Application Data
(60) Provisional application No. 63/344,489, filed on May 20, 2022.

(51) Int. Cl. B65D 19/38; B65D 71/04

(52) U.S. Cl. CPC B65D 19/385; B65D 71/04; B65D 2519/00432

(57) ABSTRACT

Implementations of the present disclosure generally relate to wrapping devices for pallet loads. Particularly, the wrapping device according to the present disclosure including edge straps for looping around corner columns of a pallet.

### CROSS-REFERENCE TO RELATED APPLICATIONS

This application claims benefit of U.S. Provisional Application Ser. No. 63/344,489, filed on May 20, 2022, which is incorporated by reference in its entirety.

### BACKGROUND

### Field

Implementations of the present disclosure generally relate device for securing and supporting goods to be transported on a transportation carrier, such as a pallet. More particularly, embodiments of the present disclosure relate to a reusable pallet wrapping assembly including edge protectors and one or more restraining straps.

### Description of the Related Art

Transportation carriers such as pallets are commonly used in the industry for moving loads for shipment. Various articles or containers are stacked on pallets to be moved from one place to another using a forklift or other mechanical device. One issue that may arise during transportation of the pallets is that the articles or containers can shift or fall that would require re-loading or even replacement of damaged articles or containers.

One solution to this issue is through the use of pallet wraps around pallets to hold the wrapped goods in position. Edge protectors are also used in addition to the wraps on edges of pallets to protect products on the pallets and prevent products from shifting horizontally during transportation. The wraps and the edge protectors are usually applied separately. The process of applying and removing the wraps and the edge protectors is labor intensive and time consuming. In addition, the edge protector can only be used once and require disposal after each use, which is not environment friendly.

Therefore, a need therefore exists for an improved, reusable device for securing goods and protecting edges in a palletized load.

### SUMMARY

Implementations of the present disclosure generally relate to wrapping devices for pallet loads. Particularly, the wrapping device according to the present disclosure including edge straps for loping around corner columns of a pallet.

Embodiments of the present disclosure provide a wrapping device for securing a pallet load to a pallet block. The wrapping device comprises four edge protectors, wherein each edge protector comprises: two edge panels joined by one edge; and one end panel attached the two edge panels, strap retainers are formed through each of the edge protectors; a horizontal strap slidingly attached to the four edge protectors, wherein the horizontal strap is attached to the four edge protectors by threading through the corresponding strap retainers; and four corner straps, wherein each of the four corner straps is connected to a corresponding one of the edge protectors, wherein the four edge protectors are configured to hang from a top surface at corners of the pallet load, and the four corner straps are configured to secure the four edge protectors to the pallet block when the pallet load is disposed on the pallet block.

### BRIEF DESCRIPTION OF THE DRAWINGS

So that the manner in which the above-recited features of the present disclosure can be understood in detail, a more particular description of the implementations, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1A is a schematic perspective view of a wrapping device according to one embodiment of the present disclosure.

FIG. 1B is a schematic perspective view of applying a wrapping device according to the present disclosure on a pallet load.

FIG. 1C is a schematic perspective view of a pallet load partially secured with a wrapping device according to the present disclosure.

FIG. 2 is a schematic partial perspective view of a wrapping device according to one embodiment of the present disclosure.

FIG. 3 is a schematic partial sectional view of a wrapping device according to one embodiment of the present disclosure.

FIGS. 4A-4D schematically illustrate an edge protector according to embodiments of the present disclosure.

To facilitate understanding, identical reference numerals have been used, where possible, to designate identical elements that are common to the figures. It is contemplated that elements and features of one implementation may be beneficially incorporated in other implementations without further recitation. It is to be noted, however, that the appended drawings illustrate only exemplary implementations of this disclosure and are therefore not to be considered limiting of its scope, for the disclosure may admit to other equally effective implementations.

### DETAILED DESCRIPTION

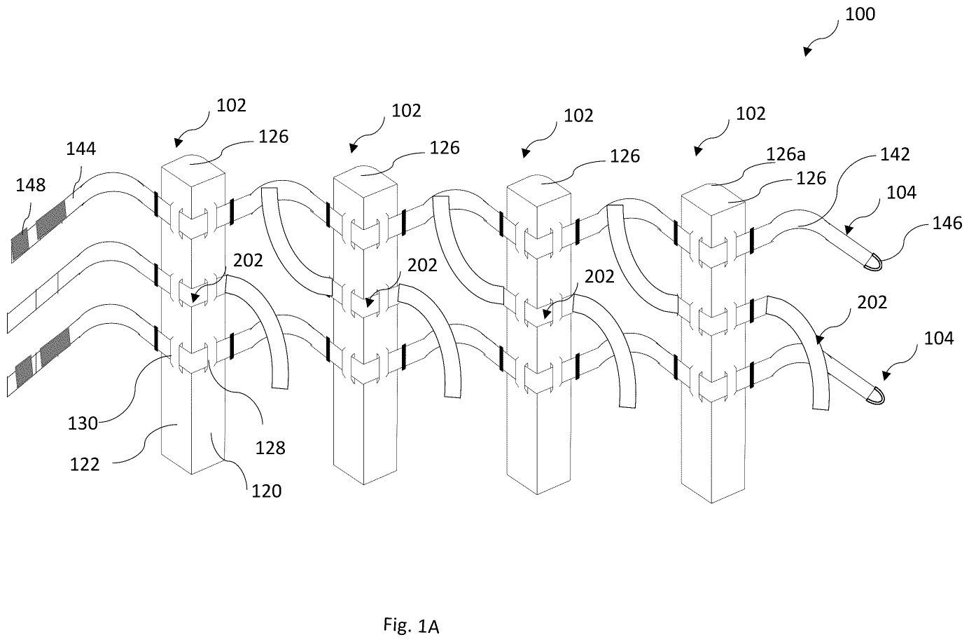

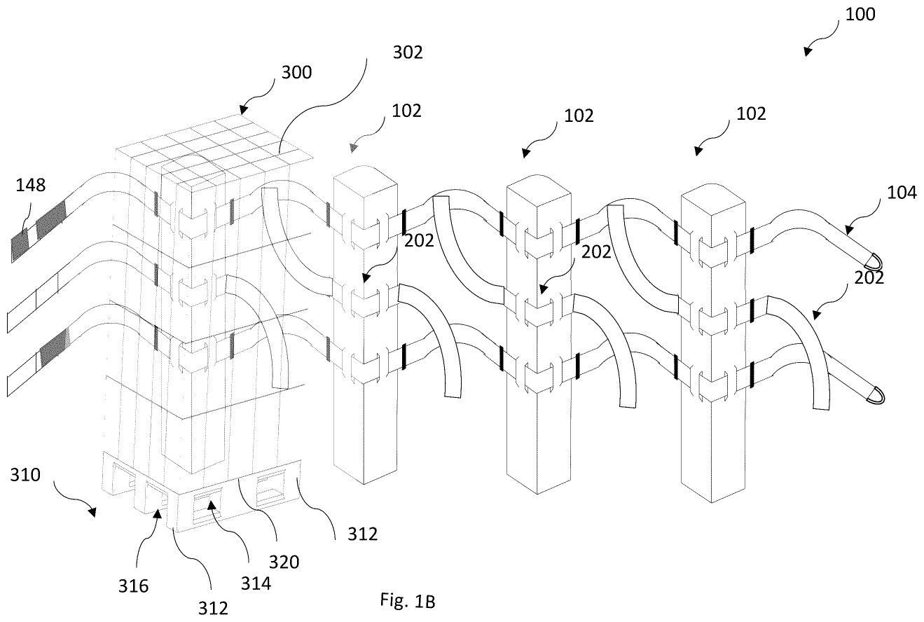

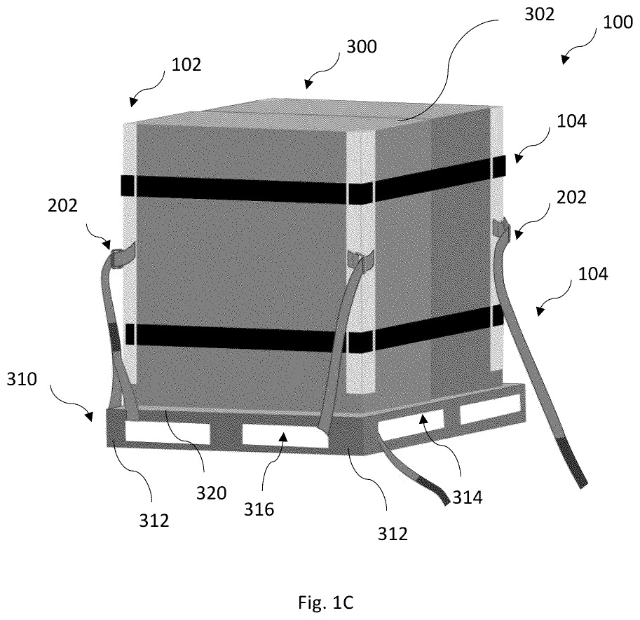

The following disclosure describes a wrapping device for securing goods on a transportation carrier such as a pallet. Details are set forth in the following description and in FIGS. 1A-1C, and 2-3 to provide a thorough understanding of various implementations of the disclosure. Many of the details, dimensions, angles and other features shown in the Figures are merely illustrative of particular implementations. Accordingly, other implementations can have other details, components, dimensions, angles and features without departing from the spirit or scope of the present disclosure. In addition, further implementations of the disclosure can be practiced without several of the details described below.

Embodiments of the present disclosure relate to a wrapping device for securing and supporting a load on a pallet during storage and transportation. More particularly, embodiments of the present disclosure provide a wrapping device including edge protectors and one or more horizontal straps threaded therethrough. In some embodiments, a corner strap may extend from each edge protector and configured to secure to a corner column of a pallet on which a load is disposed. In some embodiment, the corner strap may be directly looped through dedicated openings on the edge protector. In other embodiments, the corner strap is looped around the horizontal strap threaded through the edge protector.

FIG. 1A is a schematic perspective view of a wrapping device 100 according to one embodiment of the present disclosure. FIGS. 1B and 1C are schematic perspective views of applying the wrapping device 100 according to the present disclosure on a pallet load 300 on a pallet block 310.

The wrapping device 100 includes edge protectors 102 and one or more horizontal straps 104. In some embodiments, the wrapping device 100 includes one or more edge protectors 102. Each edge protector 102 is configured to be positioned on an edge of a pallet load. In one embodiment, the wrapping device 100 includes four edge protectors 102 for protecting four vertical edges on a rectangular prism or cubic pallet load. In other embodiments, the wrapping device 100 may include fewer or more edge protectors 102 for securing pallet loads of other shapes. Each edge protector 102 include one or more strap retainers to receive and secure the one or more horizontal straps 104. Each horizontal strap 104 is movably relative to the edge protectors 102 by sliding through the retainers. The one or more horizontal straps 104 are generally arranged parallel to each other. The number of horizontal straps 104 may be selected according to the length of edge protectors 102. As shown in FIG. 1A, each horizontal strap 104 threads through the edge protectors 102. During operation, the edge protectors 102 are first positioned one by one on edges of a pallet load. The pallet load is then secured with the wrapping device 100 by tightening and joining two ends of each horizontal straps 104.

The edge protector 102 includes a first edge panel 120 and a second edge plane 122. Each edge panel 120, 122 may be a rectangular shaped sheet material. In some embodiments, the panels 120, 122 may have identical dimensions. In other embodiments, the edge panels 120, 122 may have different shapes and/or dimensions to achieve desired functions and/or esthetic functions. In some embodiments, the edge panels 120, 122 are rectangular panels and joined at long side to form an edge 121. In some embodiments, the edge panels 120, 122 are joined at angle of about 90 degrees to conform with edges on rectangular pallet loads. Alternatively, the edge panels 120, 122 may be joined at other angles to conform with loads of other shapes.

The edge protector 102 further includes an end panel 126. The end panel 126 may be also made of sheet material. The end panel 126 are joined to both edge panels 120, 122 at short sides of the edge panels 120, 122. The edge panels 120,122 and the end panel 126 form a corner, which allows the edge protector 102 to stay on a corner of a pallet load without additional restraint. The end panel 126 may be a square shaped sheet with a round corner 126a as shown in FIGS. 1A and 1B. Alternatively, the end panel 126 may be any suitable shapes to form a structure to allow the edge panels 120, 122 to rest on pallet loads without any external support. For example, the end panel 126 may be shaped like a fan, a triangle, or other shapes.

In some embodiments, the edge protector 102 may have a high friction region in an inner surface of the end panel 126. The high friction region may have a high roughness or may include materials that generate high friction with pallet loads, thus, preventing the edge protector 102 from falling out of the pallet load before the straps are tightened up. In some embodiments, the high friction region is formed by attaching a piece of sandpaper to the inner side of the end panel 126. In some embodiments, the high friction region is formed by attaching a rubber film or plate to the inner side of the end panel 126. In some embodiments, the rubber film or plate may include protrusions. In other embodiments, the high friction region may be formed by forming a high roughness area with surface valleys and protrusions, which may be formed during molding or post formation process, such a sand bombardment.

In some embodiments, the edge panels 120, 122 include strap retainers 128, 130 respectively. The strap retainers 128, 130 may form a loop structure on the edge panel 120, 122 to allow the horizontal strap 104 to be threaded therethrough and to slide relative to the edge protector 102. In some embodiments, the strap retainers 128, 130 may be strip of sheet partially cut out from the edge panels 120, 122 to form a loop. In some embodiments, each strap retainer 128, 130 may include a strip of sheet material protruding from the edge panels 120, 122. The strap retainer 128, 130 may have a thinner thickness than the edge panels 120, 122. The strap retainers 128, 130 may be positioned symmetrically about the edge 121 on the edge panels 120, 122.

In some embodiments, the wrapping device 100 includes more than one horizontal strap 104 when the edge protector 102 is long. For example, the wrapping device 100 includes two horizontal straps 104. Each horizontal strap 104 may be a strip of cloth, leather, fabric or any suitable flexible material such as polyester, nylon, polypropylene, polyethylene, canvas, composite woven, any suitable natural or synthetic materials, or any combination thereof. The horizontal strap 104 may also be a non-stretching material made of any suitable composite or synthetic material.

Each horizontal strap 104 includes two ends 142, 144. When the wrap device 100 is in use, the two ends 142, 144 are joined together to tie the edge protectors 102 and the pallet load. The two ends 142, 144 may be used joined by any suitable ways. In some embodiments, the end 142 may include a connection ring 146 and the end 144 may include a hook-and-loop type fastener 148. The connection ring 146 may have a “D” shape or the like that is sized to allow the end 144 of the horizontal straps 104 to pass through and wrap around at least a portion of the pallet and loaded goods. The hook-and-loop type fastener 148 works with the connection rings 146 by permitting the hook-and-loop type fastener 148 to pass through and fold back and attach to themselves to secure the edge protectors 102 around the pallet load. In other embodiments, the two ends 142, 144 may be joined together by clasps, similar to the tightening structure of airplane seat belts.

In some embodiments, a corner strap 202 may be connected to each of the edge protectors 202. The corner straps 202 are configured to secure a pallet load 300 to corresponding corner columns on the pallet block 310. The corner straps 202 may be contra similar to the horizontal strap 104. Each corner strap 202 is attached to the edge protector 102. The corner straps 202 are configured to thread through the pallet block 310 to secure the corresponding edge protectors 102 to the pallet block 310. The corner strap 202 may be connected to the edge protector 102 directly, for example, by threading through the strap retainers 128, 130, as shown in FIGS. 1A-1C. Alternatively, the corner strap 202 may be attached to the edge protector 102 indirectly, for example, by attaching to the horizontal strap 104.

As shown in FIGS. 1B and 1C, the pallet load 300 is a rectangular load having four vertical edges. The pallet load 300 is disposed over the pallet block 310 so that the pallet block 310 supports the pallet load 300 during transportation. The pallet load 300 may include one or more multiple packages stacked together in a substantially column form. The pallet block 310 may have a supporting board 320, on which a pallet load is disposed. Corner columns 312 are disposed under the support board 320 forming openings 314, 316 below the supporting board 320 so that forklifts can come under the support board 320 to pick up the support board 320 and the pallet load 300. The pallet block 310 typically comes in standardized sizes, for example, may be 42 inches by 42 inches, or 48 inches by 48 inches, 42 inches by 48 inches.

To apply the wrapping device 100 on the pallet load 300 disposed on the pallet block 310, an operator may first position the edge protectors 102 sequentially on corners of the pallet load 300. Particularly, the operation may dispose the edge protectors 102 on the pallet load 300 by hanging the end panels 126 of the edge protectors 126 a top surface 302 at corners of the pallet load 300, as shown in FIG. 1B. Because the end panels 126 of the edge protectors 102 allow the edge protectors 102 to stay on the pallet load 300 before the horizontal straps 104 are tied up, the wrapping device 100 can be applied by a single operator. When all four edge protectors 102 are in place, the horizontal straps 104 may be pulled tight and opposing ends of the horizontal straps 104 tied together to secure the pallet load 300 with the wrapping device 100. One end of each of the corner straps 202 may be threaded through the corresponding openings 314, 316 on the pallet block 310 and tied up to another end, thereby securing the edge protectors 102 to the corresponding corner columns 312, as shown in FIG. 1C. The corner straps 202 are easy to apply and provide extra security to the pallet load 300.

In some embodiments, the horizontal straps 104 may be secured first and the corner straps 202 are tied up thereafter. Alternatively, one or more corner straps 202 may be tied to the pallet block 310 prior to tightening the horizontal straps 104 to ease operation or improve efficiency of operation.

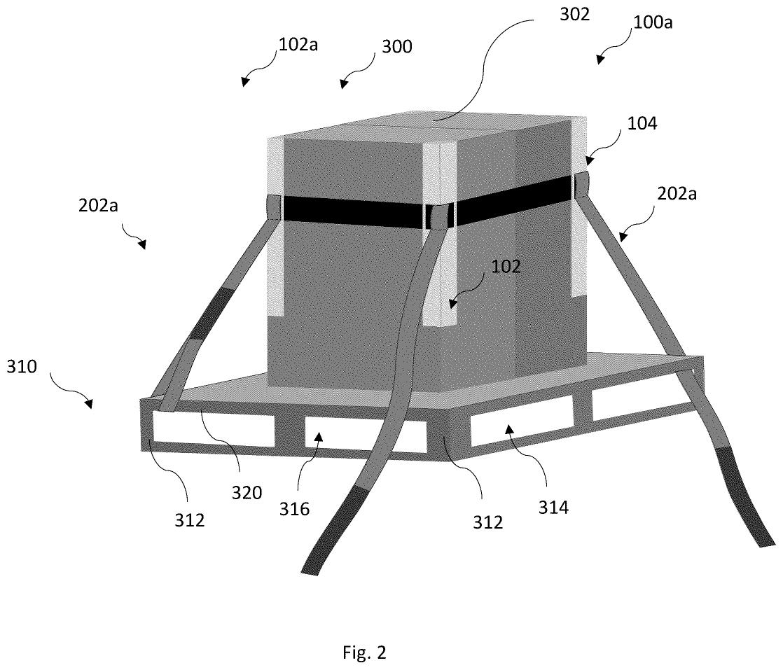

FIG. 2 is a schematic partial perspective view of a wrapping device 100a according to one embodiment of the present disclosure. The wrapping device 100a is similar to the wrapping device 100 except that the corner straps 202 are looped through portions of the horizontal strap 104 between retainers on each edge protectors 102.

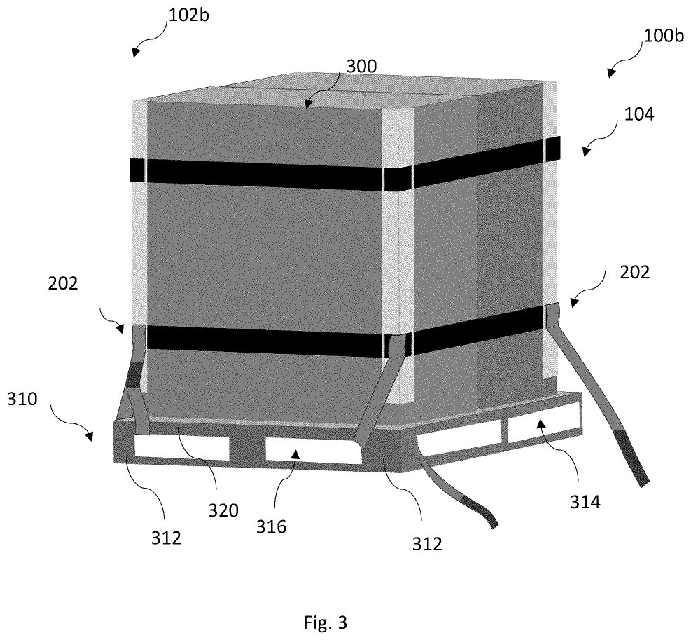

FIG. 3 is a schematic partial sectional view of a wrapping device 100b according to one embodiment of the present disclosure. The wrapping device 100b is similar to the wrapping device 100a except that the corner straps 202 are looped around the lowest one of horizontal straps 104. By attaching the corner straps 202 to the lowest horizontal strap 104, the corner straps 202 may be shorter, thus, reducing cost of material and avoid unnecessary entanglement of the straps during operation.

Edge protectors according may have various designs. For example, various designs of edge protectors are disclosed in U.S. patent application Ser. No. 16/674,285 (Published as US 2021/0130058).

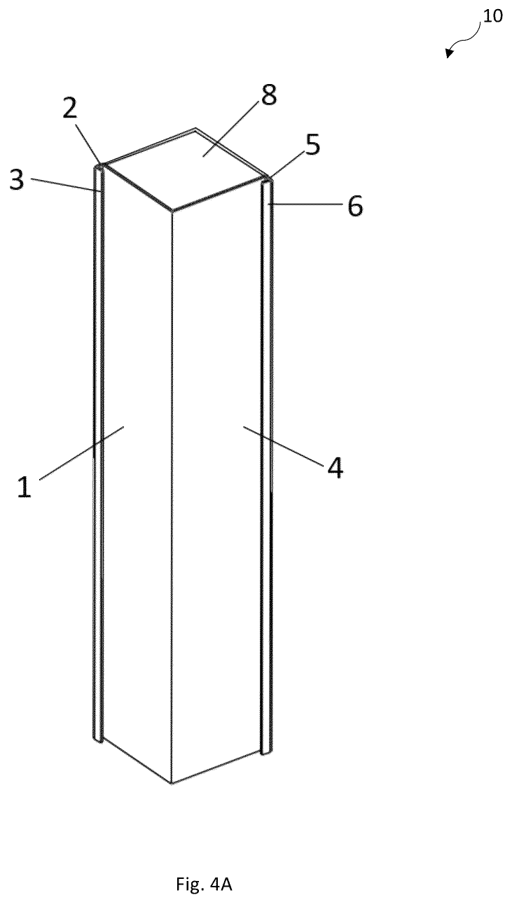

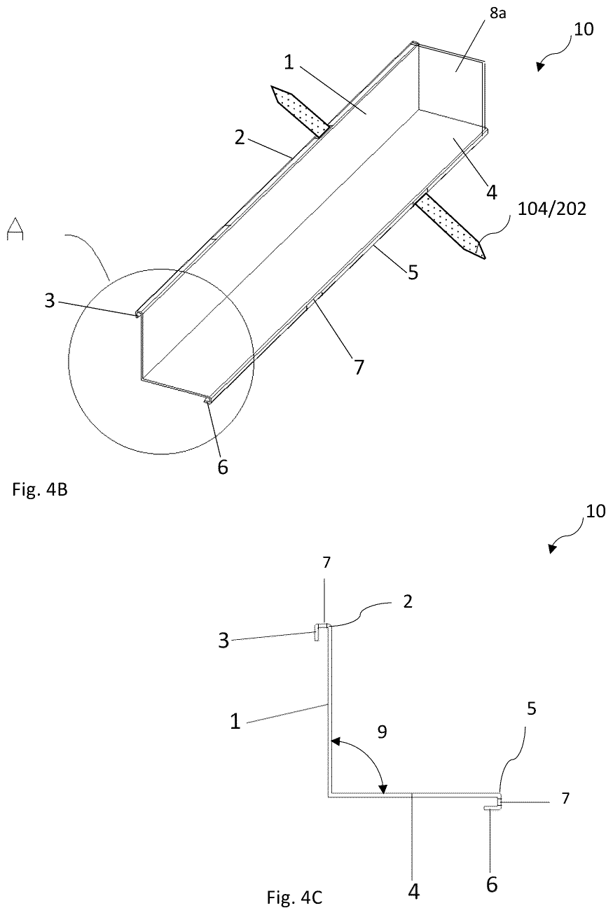

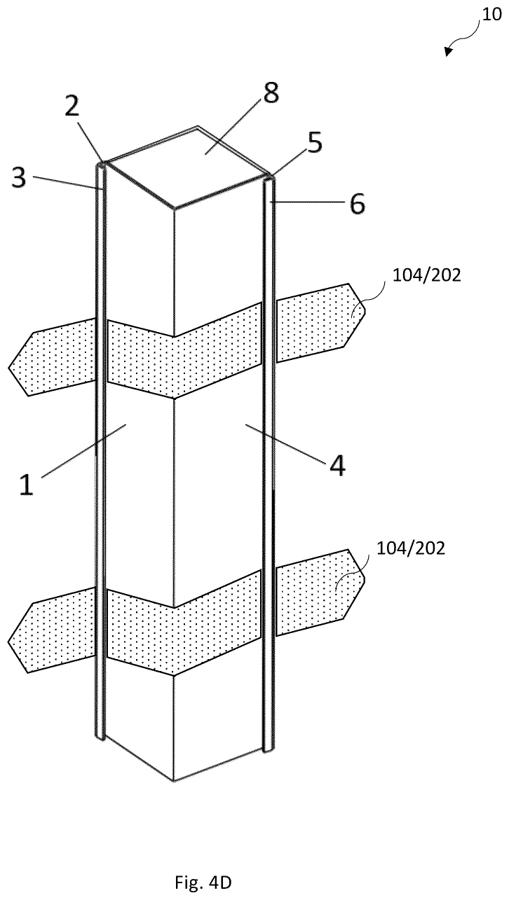

FIGS. 4A-4D schematically illustrate an edge protector 10 according to embodiments of the present disclosure. The edge protector 10 may be used in place of the edge protector 102 in the wrapping devices 100, 100a, 100b described above. FIGS. 4A and 4B are schematic perspective views of the edge protector 10. FIG. 4C is a schematic sectional view of the edge protector 10. FIG. 4D schematically illustrates a section of the edge protector 10 with straps, such as the horizontal straps 104 or the corner straps 202, threaded therethrough.

The edge protector 10 includes a first edge panel 1 and a second edge plane 4. Each edge panel 1, 4 may be a rectangular shaped sheet material. In some embodiments, the panels 1, 4 may have identical dimensions. In other embodiments, the edge panels 1, 4 may have different shapes and/or dimensions to achieve desired functions and/or esthetic functions. In some embodiments, the edge panels 1, 4 are rectangular panels and joined at long side to form an edge. The edge panels 1, 4 form an angle 9 configured to wrap around an edge of a pallet load. In some embodiments, the edge panels 1, 4 are joined at angle of about 90 degrees to conform with edges on rectangular pallet loads. The edge protector 10 further includes an end panel 8. The end panel 8 are joined to both edge panels 1, 4 at short sides of the edge panels 1, 4. The edge panels 1, 4 and the end panel 8 form a corner, which allows the edge protector 10 to stay on a corner of a pallet load without additional restraint. The end panel 8 may be a square shaped. In some embodiments, a high friction material may be formed or attached to an inner surface 8a of the end panel 8.

In some embodiments, the edge protector 10 are formed from folded panels. As shown in FIG. 4C, the edge panels 1, 4 are joint to each other at proximal edges. Distal edges of the edge panels 1, 4 are folded outwards from the angle 9. In some embodiments, panels 2, 3 are sequentially formed along the distal edge of the edge panel 1. In some embodiments, the panel 2 is folded at a first angel from the edge panel 1, and the panel 3 is folded at a second angel from the panel 2. In some embodiments, the first and second angles are about 90 degrees. Alternatively, the first and second angles may be selected at any angles suitable for functional or atheistic purposes. In some embodiments, the panel 3 may be omitted. Similarly, panels 5, 6 are sequentially formed along the distal edge of the edge panel 4. In some embodiments, the panel 5 is folded at a third angel from the edge panel 4, and the panel 6 is folded at a fourth angel from the panel 5. In some embodiments, the third and fourth angles are about 90 degrees. Alternatively, the third and fourth angles may be selected at any angles suitable for functional or atheistic purposes. In some embodiments, the panel 6 may be omitted.

One or more through holes 7 are formed through the panels 2 and 5. The through holes 7 are configured to function as strap retainer. As shown in FIGS. 4B and 4D, straps, such as corner straps 202, and horizontal straps 104, may be threaded through the through holes 7 to attach to the edge panel.

In some embodiments, the edge protector 10 may be fabricated from a metal sheeting, such as an aluminum sheeting. The edge protector 10 may be fabricated by punching through holes 7 at suitable positions on an elongated metal sheeting, then folding the metal sheeting to form the angle 9, and the panels 1, 2, 3, and the panels 4, 5, 6. The end panel 8 may be attached by suitable techniques, such as welding.

The edge protector 10 may be fabricated by punching the through holes 7 at rolled edges of angle material with rolled edges, such as commercially available aluminum angles.

Embodiments of the present disclosure provide a wrapping device for securing a pallet load to a pallet block. The wrapping device comprises four edge protectors, wherein each edge protector comprises: two edge panels joined by one edge; and one end panel attached the two edge panels, strap retainers are formed through each of the edge protectors; a horizontal strap slidingly attached to the four edge protectors, wherein the horizontal strap is attached to the four edge protectors by threading through the corresponding strap retainers; and four corner straps, wherein each of the four corner straps is connected to a corresponding one of the edge protectors, wherein the four edge protectors are configured to hang from a top surface at corners of the pallet load, and the four corner straps are configured to secure the four edge protectors to the pallet block when the pallet load is disposed on the pallet block.

In some embodiments of the wrapping device, each of the corner straps is looped around a portion of the horizontal strap near the corresponding edge protector.

In some embodiments of the wrapping device, each of the corner straps is looped on the horizontal strap disposed between two of the strap retainers in the corresponding edge protector.

In some embodiments of the wrapping device, each of the four protectors further comprises: two folded panels connected to the two edge panels at distal edges of the two edge panels, wherein the strap retainers are through holes formed through the two folded panels.

In some embodiments of the wrapping device, each corner strap is connected to the strap retainers of the corresponding edge protectors.

In some embodiments of the wrapping device, each of the four protectors further comprises two first folded panels connected to the two edge panels at distal edges of the two edge panels, wherein the strap retainers are through holes formed through the two first folded panels.

In some embodiments of the wrapping device, each of the four protectors further comprises two second folded panels connected to the two first folded panels.

While the foregoing is directed to implementations of the present disclosure, other and further implementation of the disclosure may be devised without departing from the basic scope thereof, and the scope thereof is determined by the claims that follow.

1. A wrapping device for securing a pallet load to a pallet block, comprising:
four edge protectors, wherein each edge protector comprises:
two edge panels joined by one edge; and
one end panel attached the two edge panels,
strap retainers are formed through each of the edge protectors;
a horizontal strap slidingly attached to the four edge protectors, wherein the horizontal strap is attached to the four edge protectors by threading through the corresponding strap retainers; and
four corner straps, wherein each of the four corner straps is connected to a corresponding one of the edge protectors,
wherein the four edge protectors are configured to hang from a top surface at corners of the pallet load, and the four corner straps are configured to secure the four edge protectors to the pallet block when the pallet load is disposed on the pallet block.

2. The wrapping device of claim 1, wherein each of the corner straps is looped around a portion of the horizontal strap near the corresponding edge protector.

3. The wrapping device of claim 2, wherein each of the corner straps is looped on the horizontal strap disposed between two of the strap retainers in the corresponding edge protector.

4. The wrapping device of claim 3, where each of the four protectors further comprises:
two folded panels connected to the two edge panels at distal edges of the two edge panels, wherein the strap retainers are through holes formed through the two folded panels.

5. The wrapping device of claim 1, wherein each corner strap is connected to the strap retainers of the corresponding edge protectors.

6. The wrapping device of claim 4, where each of the four protectors further comprises:
two folded panels connected to the two edge panels at distal edges of the two edge panels, wherein the strap retainers are through holes formed through the two folded panels.

7. The wrapping device of claim 1, where each of the four protectors further comprises:
two first folded panels connected to the two edge panels at distal edges of the two edge panels, wherein the strap retainers are through holes formed through the two first folded panels.

8. The wrapping device of claim 7, where each of the four protectors further comprises:
two second folded panels connected to the two first folded panels.
